(19) United States
(12) Patent Application Publication
(10) Pub. No.: US 2007/0159062 A1
(43) Pub. Date: Jul. 12, 2007

(54) Light-enhanced element

(75) Inventors: Kai-Shon Tsai, Lujhou City (TW); Kuan-Ta Lee, Lujhou City (TW)

Correspondence Address: BIRCH STEWART KOLASCH & BIRCH, PO BOX 747, FALLS CHURCH, VA, 22040-0747, US

(73) Assignee: Luminoso Photoelectric Technology Co.

(21) Appl. No.: 11/475,894

(22) Filed: Jun. 28, 2006

Related U.S. Application Data
(63) Continuation-in-part of application No. 11/330,331, filed on Jan. 12, 2006.

(30) Foreign Application Priority Data
Mar. 22, 2006 (TW) 095109935

(51) Int. Cl. H01J 1/62

(52) U.S. Cl. 313/501

(57) ABSTRACT

The present invention provides a light-enhanced element including a transparent element including a fluorescent brightening agent, wherein the fluorescent brightening agent can absorb the first light emitted by a light-emitting element, and subsequently emits the second light having a wavelength longer than that of the first light.

### BACKGROUND OF THE INVENTION

1. Field of the Invention

The present invention generally relates to a transparent element, and in particular to a light-enhanced element which is a transparent element including a fluorescent brightening agent. The brightness of the light source is greatly increased when light emitted from the light source passes through such a light-enhanced element.

2. The Prior Arts

The fluorescent materials can be applied in many fields, and are mainly applied in cleaner (such as soaps and detergents), paper, textile, plastic, oil, painting, and the like. With the development of science and technology, the applied range of fluorescent materials has been expanded. For example, the fluorescent materials can be applied in the fluorescent probes, lasers, and especially in the LEDs nowadays. However, in LED technologies, most of the researches have been focused on the inorganic fluorescent materials, called the phosphors, which absorb UV light and re-emit it as visible light. However, the inorganic phosphors can cause the problems of heavy metal pollution, metal radiation, and the like. Moreover, these inorganic phosphors have some limit on brightness enhancement. For example, the brightnesses of the conventional LEDs with inorganic phosphors are usually not enough for use in illumination systems. One of the reasons is that the inorganic phosphors, such as YAG or TAG, only can be dispersed in the solvent, and if the used amount of the inorganic phosphors is increased in order to improve the brightness of a LED, the inorganic phosphor particles will aggregate together into larger particles which can shield light, and consequently the brightness of the LED cannot be further increased. Moreover, when a blue LED chip is in combination with a yellow-emitting phosphor YAG:Ce embedded in the epoxy dome as a light converter, the LED device will emit yellowish white light if the used amount of YAG is increased. Also, the problems of color spots (such as black or yellow spots) and halo phenomena occurred in the conventional LED exist. Therefore, there is a need for developing an environmental friendly light-emitting devices, such as LED devices, or fluorescent lamps, have high brightness and high luminous efficiency to overcome the shortcomings described above. In other applied areas, in the case of panel display devices, the panel display brightness is conventionally increased by increasing the brightness of the light source of the backlight module, and consequently the energy consumption is very high in global view. Therefore, there is also a need for developing a energy-save panel display device without changing the original design of the device.

### SUMMARY OF THE INVENTION

Accordingly, the objective of the present invention is to provide a light-enhanced element for increasing the brightnesses of the light emitting devices or the panel display devices without changing their original design.

To achieve the foregoing objective, the present invention provide a light-enhanced element, comprising a transparent element including a fluorescent brightening agent, wherein the fluorescent brightening agent can absorb part of the first light emitted from the light source of a light emitting device or a panel display device, which subsequently emits the second light having a wavelength longer than that of the first light.

Any fluorescent brightening agent, which is capable of absorbing part of the first light having a wavelength of 250 nm-470 nm emitted by the light source, and subsequently emitting the second light having a wavelength of 380 nm-660 nm, can be used in the present invention.

The light-enhanced element of the present invention can further comprise a photoluminescent phosphor, wherein the photoluminescent phosphor can absorb part of the first light emitted from the light source, and subsequently emit the third light having a wavelength longer than that of the first light.

It is worthy to be noticed that the fluorescent brightening agents used in the present invention can substantially completely absorb the light having a wavelength between 250 nm and 470 nm, and subsequently re-emit it as a visible light with very high luminescence efficiency, and thus only a trace amount of the fluorescent brightening agents are needed for greatly increasing the brightnesses of the light emitting devices or the panel display devices. If the light emitting devices or the panel display devices include the light-enhanced element of the present invention for brightness enhancement, the energy consumption will be saved in average about 10% to 20%. Moreover, the fluorescent brightening agents used in the present invention are environmental-friendly materials, and they will not cause heavy metal pollution and harmful metal radiation problems.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the first embodiment of the present invention;

FIG. 2 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the first embodiment of the present invention;

FIG. 3 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the second embodiment of the present invention;

FIG. 4 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the second embodiment of the present invention;

FIG. 5 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the third embodiment of the present invention;

FIG. 6 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the third embodiment of the present invention;

FIG. 7 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the fourth embodiment of the present invention;

FIG. 8 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the fourth embodiment of the present invention;

FIG. 9 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the fifth embodiment of the present invention;

FIG. 10 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, according to the fifth embodiment of the present invention;

FIG. 11 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the sixth embodiment of the present invention;

FIG. 12 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the sixth embodiment of the present invention;

FIG. 13 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the seventh embodiment of the present invention;

FIG. 14 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the seventh embodiment of the present invention;

FIG. 15 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the eighth embodiment of the present invention;

FIG. 16 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the eighth embodiment of the present invention;

FIG. 17 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively according to the ninth embodiment of the present invention;

FIG. 18 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the ninth embodiment of the present invention;

FIG. 19 is the brightness (LM) versus time profiles illustrating the variation in the brightness of LED encapsulated in silicone resin containing the fluorescent brightening agent and measured at a distance of 30 cm, and 50 cm every 24 hours, respectively, and the variation in the brightness of LED encapsulated in pure silicone resin not containing the fluorescent brightening agent and measured at a distance of 30 cm, and 50 cm every 24 hours, respectively, according to the tenth embodiment of the present invention;

FIG. 20 is the brightness increment (%) versus time profiles illustrating the increment percentage of the brightness of LED encapsulated in silicone resin containing the fluorescent material with respect to the brightness of LED encapsulated in pure silicone resin not containing the fluorescent material measured at a distance of 30 cm, and 50 cm, respectively, according to the tenth embodiment of the present invention;

FIG. 21 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the eleventh embodiment of the present invention;

FIG. 22 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twelfth embodiment of the present invention;

FIG. 23 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the thirteenth embodiment of the present invention;

FIG. 24 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the fourteenth embodiment of the present invention;

FIG. 25 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the fifteenth embodiment of the present invention;

FIG. 26 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the sixteenth embodiment of the present invention;

FIG. 27 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the seventeenth embodiment of the present invention;

FIG. 28 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the eighteenth embodiment of the present invention;

FIG. 29 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the nineteenth embodiment of the present invention;

FIG. 30 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twentieth embodiment of the present invention;

FIG. 31 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-first embodiment of the present invention;

FIG. 32 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-second embodiment of the present invention;

FIG. 33 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-third embodiment of the present invention;

FIG. 34 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-fourth embodiment of the present invention;

FIG. 35 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-fifth embodiment of the present invention;

FIG. 36 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-sixth embodiment of the present invention;

FIG. 37 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-seventh embodiment of the present invention;

FIG. 38 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-eighth embodiment of the present invention;

FIG. 39 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the twenty-ninth embodiment of the present invention;

FIG. 40 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the thirtieth embodiment of the present invention;

FIG. 41 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the thirty-first embodiment of the present invention;

FIG. 42 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the thirty-second embodiment of the present invention; and

FIG. 43 is the brightness versus test position profiles illustrating the variation in the brightness at three different test spots on the light-enhanced acrylic plate, and the variation in the brightness at the three different test spots on the conventional acrylic plate as a control plate when each acrylic plate is illuminated from its two sides by a blue LED according to the thirty-third embodiment of the present invention.

### DETAILED DESCRIPTION OF THE PREFERRED EMBODIMENT

The present invention provide a light-enhanced element, comprising a transparent element including a fluorescent brightening agent, wherein the fluorescent brightening agent can absorb part of the first light emitted from the light source, and subsequently emits the second light having a wavelength longer than that of the first light, wherein the wavelength of the first light is in the range of 250 nm to 470 nm, and the wavelength of the second light is in the range of 380 nm to 660 nm. In the present invention, the transparent element including the fluorescent brightening agent can be fabricated by dissolving a trace amount of fluorescent brightening agent in an organic solvent to make a fluorescent brightening agent solution, followed by applying the fluorescent brightening agent solution to a transparent element and drying. Alternatively, the transparent element including the fluorescent brightening agent can be fabricated by dissolving a trace amount of fluorescent brightening agent in an organic solvent to make a fluorescent brightening agent solution, followed by mixing the fluorescent brightening agent solution with a transparent element material and then molding the mixture into the desired shape. Examples of suitable organic solvents include, but are not limited to, acetone, methyl alcohol, ethyl alcohol, isopropyl alcohol, ethyl ether, methyl isopropyl ether and mixtures thereof. The light-emitting element or the light source used in the present invention can be any element which can emit light including blue light, UV light or both when electronically activated. The suitable light-emitting elements include, but are not limited to, fluorescent lamps, and LED chips. The transparent element used in the present invention can be any element which is transparent to light or radiation. The suitable transparent elements include, but are not limited to, encapsulation layer for LED, light guide plate for a backlight module, fluorescent light tube, and lampshade. It is worthy of note that only a trace amount of the fluorescent brightening agent is needed to be coated on the transparent element or mixed with the transparent element material to make the light passing through such a transparent element to look significantly brighter. In the case of an encapsulation layer (which is made of a resin composition including a transparent resin, and a fluorescent brightening agent) for LED as a light-enhanced element, the transparent resin, such as silicone resin or epoxy resin, is present in an amount of from 99.99 to 99.9% by weight of total weight of the resin composition for the encapsulation layer, and the fluorescent brightening agent is present in an amount of from 0.01 to 0.1% by weight of total weight of the resin composition for the encapsulation layer. In the case of a light guide plate (which is made of a resin composition including a acrylic resin, and a fluorescent brightening agen) for a backlight module as a light-enhanced element, the acrylic resin (which is polymethylmethacrylate, PMMA) is present in an amount of from 99.99 to 99.95% by weight of total weight of the resin composition for the light guide plate, and the fluorescent brightening agent is present in an amount of from 0.01 to 0.05% by weight of total weight of the resin composition for the light guide plate.

The light-enhanced element of the present invention can further comprise a photoluminescent phosphor. The term “photoluminescent phosphor” includes quite generally all solid and liquid, inorganic and organic materials capable of converting an input of absorbed photons into an output of photons of different energy, and the output comprises a visible light with a brightness and intensity sufficient for visual display. The photoluminescent phosphor can be mixed with the fluorescent brightening agent and then coated on or or contained in a transparent element for use. Alternatively, the photoluminescent phosphor can be directly coated on or under the fluorescent brightening agent over a transparent element. Examples of suitable photoluminescent phosphor include, but are not limited to, YAG, TAG, and Zex, which can emits a yellow light having a wavelength in the range of 530 to 590 nm. In one embodiment of the present invention, a light emitting device comprises a light-emitting element, and a transparent element including both a fluorescent brightening agent and a photoluminescent phosphor, wherein the light-emitting element can emit the first light, which excites both the fluorescent brightening agent and the photoluminescent phosphor contained in or coated on the transparent element, and subsequently emits the second light and the third light, respectively, and consequently the unabsorbed first light, the second light, and the third light are combined in the transparent element, and emitted it outwards from the transparent element. Either the second light or the third light has longer wavelength than that of the first light. If the transparent element as just described above is an encapsulation layer (which is made of a resin composition including a transparent resin, a fluorescent brightening agent, and a photoluminescent phosphor) for LED, the transparent resin, such as silicone resin or epoxy resin, is present in an amount of from 84.9 to 94.99% by weight of total weight of the resin composition for the encapsulation layer, and the fluorescent brightening agent is present in an amount of from 0.01 to 0.1% by weight of total weight of the resin composition for the encapsulation layer, and the photoluminescent phosphor is present in an amount of from 5.00 to 15.00% by weight of total weight of the resin composition for the encapsulation layer.

The fluorescent brightening agent used in the present invention is any organic fluorescent brightening agent capable of emitting visible light having a wavelength of 380 to 660 nm upon excitation with light. Examples of suitable fluorescent brightening agents include, but are not limited to, stilbene, benzooxazole, 9-oxo-xanthene, N-methyl-1,8-naphthyl-imide, 3-(4-chlorophenyl)pyrazoline, pyrazoline, imidazole, 1,2,4-triazole, oxazolidine-2-one, 1,8-naphthyl-imide, 4,4′-bis(2-methoxystyryl)-1,1′-biphenyl, 4,4′-bis(2-(1-pyrenyl)ethenyl)-1,1′-biphenyl, 4,4′-bis(2-(9-phenanthrenyl)ethenyl)-1,1′-biphenyl, 4,4′-bis(2-(9-anthracenyl)ethenyl)-1,1′-biphenyl, 4,4′-bis(2-(1-anthraquinonyl)ethenyl)-1,1′-biphenyl, 4,4′-bis{2-(2-fluorenyl)ethenyl}-1,1′-biphenyl, 1,4-bis(2-cyanostyryl)benzene, 1,4-bis(2-benzoxazoly)naphthalene, 2,5-bis(5-tertbutyl-2-benzoxazolyl)thiophene, 2,5-bis(2-benzoxazolyl)thiophene, 4,4-bis(benzoxazoyl)stilbene, 4,4′-bis(5-methyl-2-benzoxazolyl)stilbene, 1,2-bis(5-methyl-2-benzoxazolyl)ethylene, ethyl 5,6-benzocoumarin-3-carboxylate, 3-phenyl-5,6-benzocoumarin, N-methyl-4,5-diethoxy-1,8-naphthyl-imide, N-methyl-4-methoxy-1,8-naphthyl-imide, 3-(4-chlorophenyl)-1,5-diphenyl-2-pyrazoline, 3-(4-chlorophenyl)-1-phenyl-pyrazole, 4-methyl-7-diethylaminocoumarin, 1-(p-methanesulfonylphenyl)-3-(p-chlorophenyl)-2-pyrazoline, 1-(p-sulfonamidophenyl)-3-(p-chlorophenyl)-2-pyrazoline, pyrene, and any combination thereof. The fluorescent brightening agents listed above can substantially completely absorb the light having wavelength between 250 nm and 470 nm, and subsequently re-emits it as a visible light with very high brightness.

On the other hand, if the structures of the fluorescent brightening agents have the stilbene moiety, or the distyrylbiphenyl moiety, any chromophore groups, such as methoxyphenyl group, anthracene group, pyrene group, or 9,10-anthraquinone group, can be symmetrically bonded to such a stilbene moiety or distyrylbiphenyl moiety for enhancing the brightness of the light-emitting device including such a fluorescent brightening agent. Examples of such fluorescent brightening agents include, but are not limited to, 4,4′-bis(2-methoxystyryl)biphenyl, 4,4′-bis{2-(9-anthracenyl)ethylenyl}biphenyl, 4,4′-bis{2-(1-pyrenyl)ethylenyl}biphenyl, and 4,4′-bis{2-(1-anthraquinonyl)ethylenyl}biphenyl. When 4,4′-bis(2-methoxystyryl)biphenyl is used as the fluorescent brightening agent, it can be excited by UV light and subsequently emits a blue light having a wavelength between 450 nm and 490 nm. When 4,4′-bis{2-(9-anthracenyl)ethylenyl}biphenyl is used as the fluorescent material, it can be excited by UV light and subsequently emits a yellowish-green light having a wavelength between 520 nm and 550 nm. When 4,4′-bis{2-(1-pyrenyl)ethylenyl}biphenyl is used as the fluorescent material, it can be excited by UV light and subsequently emits a blue light having a wavelength between 450 nm and 490 nm. When 4,4′-bis{2-(1-anthraquinonyl)ethylenyl}biphenyl is used as the fluorescent material, it can be excited by UV light and subsequently emits a red light having a wavelength between 580 nm and 660 nm. In order to achieve the optimum brightness level of LED, a blue phosphor is used with 4,4′-bis(2-methoxystyryl)biphenyl, or 4,4′-bis{2-(1-pyrenyl)ethylenyl}biphenyl to convert the emission of the LED chip to a blue light; a yellowish green phosphor is used with 4,4′-bis{2-(9-anthracenyl)ethylenyl}biphenyl to convert the emission of the LED chip to a yellowish green light; and a red phosphor is used with 4,4′-bis{2-(1-anthraquinonyl)ethylenyl}biphenyl to convert the emission of the LED chip to a red light.

### EXAMPLE 1

A GaN LED is die bonded and wire bonded to a PCB. 0.5% by weight of stilbene fluorescent brightening solution is prepared by dissolving stilbene used as a fluorescent brightening agent in acetone. Then, the stilbene-resin mixture is prepared by mechanically mixing 98.0% by weight of silicone resin with 2% by weight of 0.5% stilbene fluorescent brightening solution. Subsequently, the light-enhanced LED device is obtained by encapsulating the GaN LED chip with the fluorescent brightening agent-silicone resin mixture and dried. The stilbene structure is shown as following:

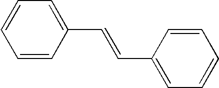

In addition, a conventional LED device is obtained by encapsulating a GaN LED chip with pure silicone resin and dried.

Brightness Test

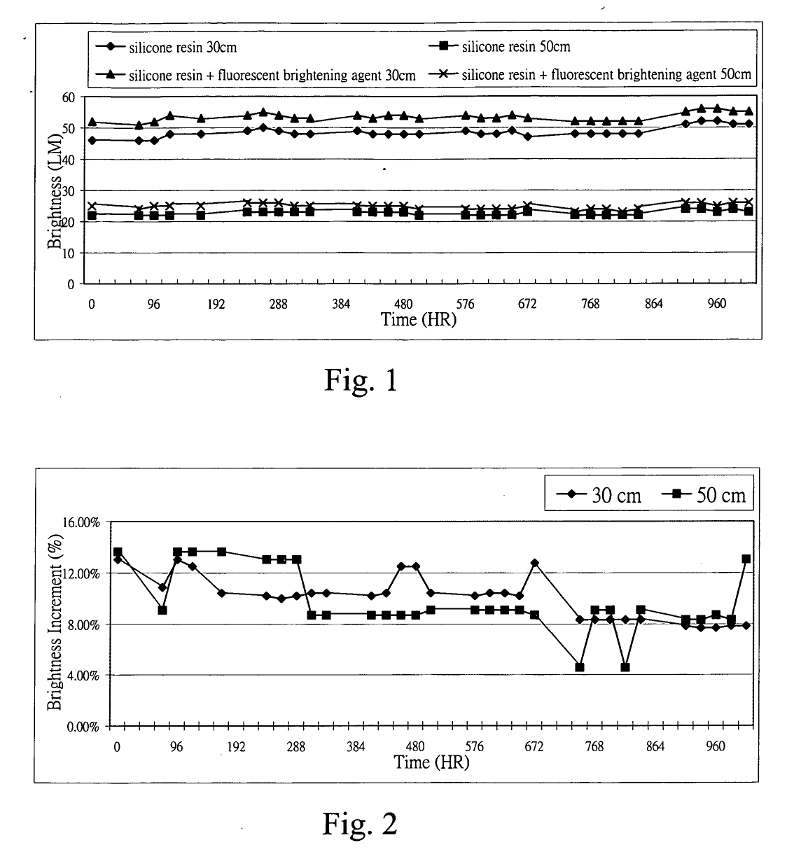

The light-enhanced LED device, sealed with a transparent encapsulation layer which is made of stilbene-silicone resin mixture, emits a blue light with a wavelength of about 465 nm when subjected to a voltage of 3.6 V, and the blue light emitted outward excites the stilbene fluorescent brightening agent contained in the transparent encapsulation layer, undergoes wavelength conversion, and is emitted outward as a blue light with a wavelength of about 475-485 nm. The brightness (LM) of the blue light with a wavelength of about 475-485 nm is measured by Illuminance Meter at the height of 30 cm, and 50 cm every 24 hours, respectively, until the total measured time reaches a setting value of 960 hours. The measurement results are shown in FIG. 1. Likewise, the conventional LED device sealed with a transparent encapsulation layer made of pure silicone resin emits a blue light with a wavelength of about 465 nm when subjected to a voltage of 3.6 V, and the blue light is emitted outward through the transparent encapsulation layer. The brightness (LM) of the blue light with a wavelength of about 465 nm is measured at the height of 30 cm, and 50 cm every 24 hours, respectively, until the total measured time reaches a setting value of 960 hours. The measurement results are also shown in FIG. 1.

The brightness increment (%) are calculated from the data given in FIG. 1, and the calculated results are shown in FIG. 2. The brightness increment (%) is calculated by dividing the difference between the brightness of emitted blue light after passing through the transparent encapsulation layer made of stilbene-silicone resin mixture and the brightness of emitted blue light after passing through the transparent encapsulation layer only made of pure silicone resin, by the brightness of the emitted blue light after passing through the transparent encapsulation layer only made of pure silicone resin at the height of 30 cm, and 50 cm, respectively. The brightness is increased in average by 10.06% at the height of 30 cm, and the brightness is increased in average by 9.746% at the height of 50 cm. Therefore, if the transparent resin encapsulation layer used for encapsulating LED chip contains a trace amount of stilbene as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 2

The light-enhanced LED device is fabricated by the same method as in EXAMPLE 1 except that benzooxazole is used as a fluorescent brightening agent instead of stilbene. The conventional LED device fabricated in EXAMPLE 1 is used. The benzooxazole structure is shown as following: 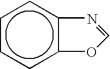
Brightness Test

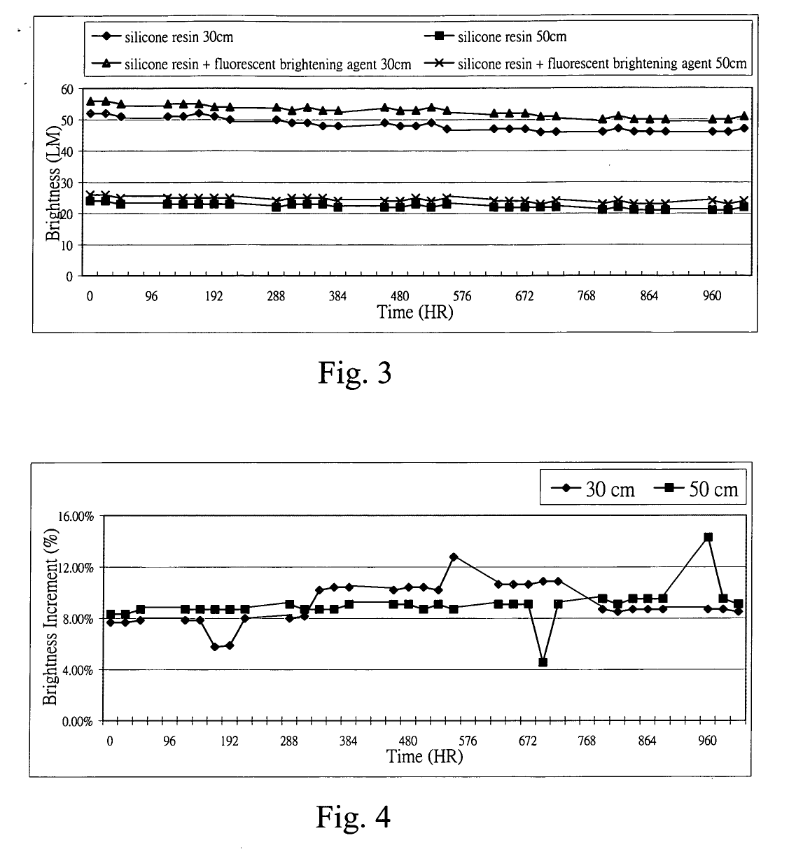

By using the same method for measuring the brightness as in EXAMPLE 1, the brightness (LM) of the blue light, emitted from GaN LED chip, after passing through a transparent encapsulation layer made of benzooxazole-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 3. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 3.

By using the same calculation method as in Example 1, the brightness increment percentages at the height of 30 cm, and 50 cm are calculated from the data given in FIG. 3, respectively, and the results are plotted in FIG. 4. The brightness is increased in average by 9.12% at the height of 30 cm, and the brightness is increased in average by 8.99% at the height of 50 cm. Therefore, if the transparent resin encapsulation layer used for encapsulating LED chip contains a trace amount of benzooxazole as a fluorescent brightening agent, the brightness of light emitted from LED chip will be greatly enhanced after passing passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 3

The light-enhanced LED device is fabricated by the same method as in EXAMPLE 1 except that 9-oxo-xanthene is used as a fluorescent brightening agent instead of stilbene. The conventional LED device fabricated in EXAMPLE 1 is used. The 9-oxo-xanthene structure is shown as following: 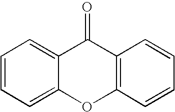
Brightness Test

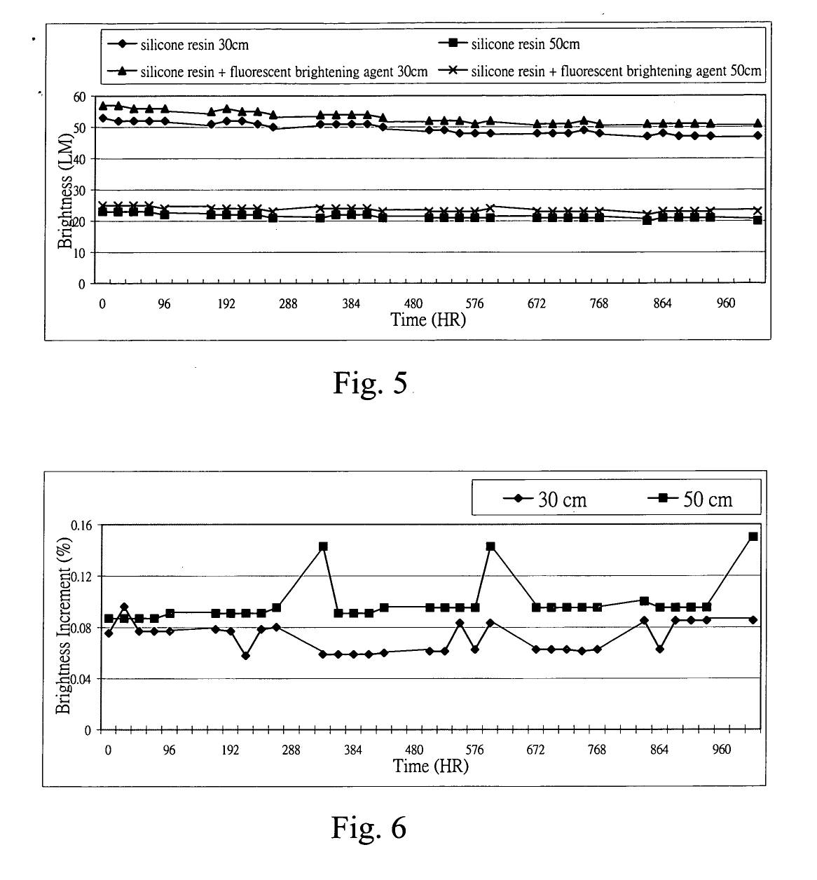

By using the same method for measuring the brightness as in EXAMPLE 1, the brightness (LM) of the blue light, emitted from GaN LED chip, after passing through a transparent encapsulation layer made of 9-oxo-xanthene-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 5. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 5.

By using the same calculation method as in Example 1, the brightness increment percentages at the height of 30 cm, and 50 cm are calculated from the data given in FIG. 5, respectively, and the results are plotted in FIG. 6. The brightness is increased in average by 7.16% at the height of 30 cm, and the brightness is increased in average by 9.80% at the height of 50 cm. Therefore, if the transparent resin encapsulation layer used for encapsulating LED chip contains a trace amount of 9-oxo-xanthene as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 4

The light-enhanced LED device is fabricated by the same method as in EXAMPLE 1 except that N-methyl-1,8-naphthyl-imide is used as a fluorescent brightening agent instead of stilbene. The conventional LED device fabricated in EXAMPLE 1 is used. The N-methyl-1,8-naphthyl-imide structure is shown as following: 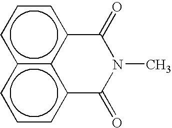
Brightness Test

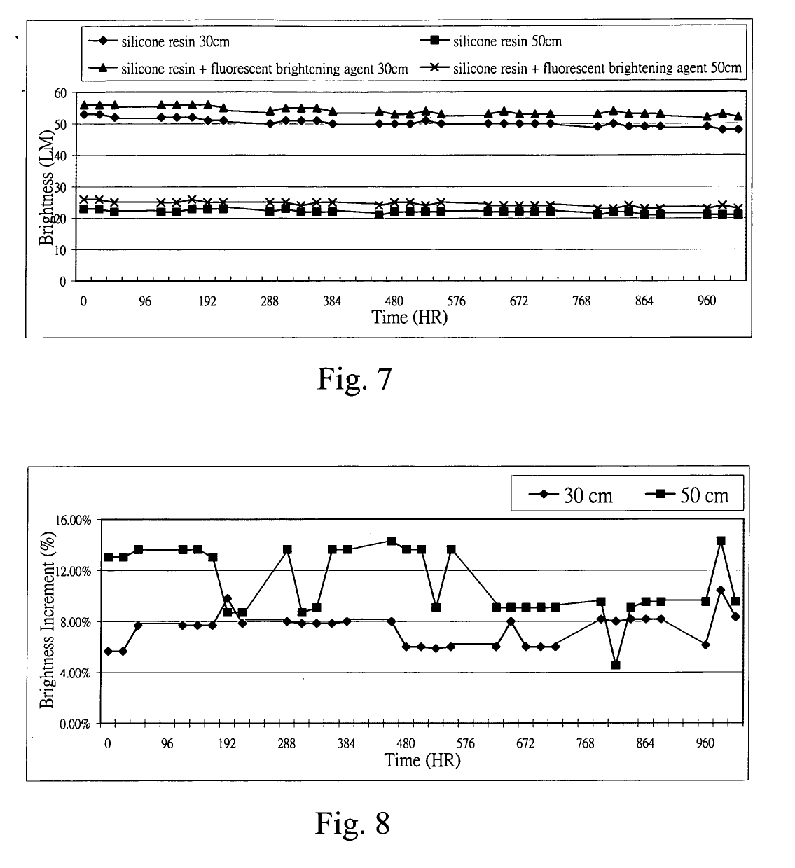

By using the same method for measuring the brightness as in EXAMPLE 1, the brightness (LM) of the blue light, emitted from GaN LED chip, after passing through a transparent encapsulation layer made of N-methyl-1,8-naphthyl-imide-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 7. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 7.

By using the same calculation method as in Example 1, the brightness increment percentages at the height of 30 cm, and 50 cm are calculated from the data given in FIG. 7, respectively, and the results are plotted in FIG. 8. The brightness is increased in average by 7.38% at the height of 30 cm, and the brightness is increased in average by 11.01% % at the height of 50 cm. Therefore, if the transparent resin encapsulation layer used for encapsulating LED chip contains a trace amount of N-methyl-1,8-naphthyl-imide as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 5

The light-enhanced LED device is fabricated by the same method as in EXAMPLE 1 except that 3-(4-chlorophenyl)pyrazoline is used as a fluorescent brightening agent instead of stilbene. The conventional LED device fabricated in EXAMPLE 1 is used. The 3-(4-chlorophenyl) pyrazoline structure is shown as following: 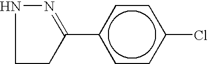
Brightness Test

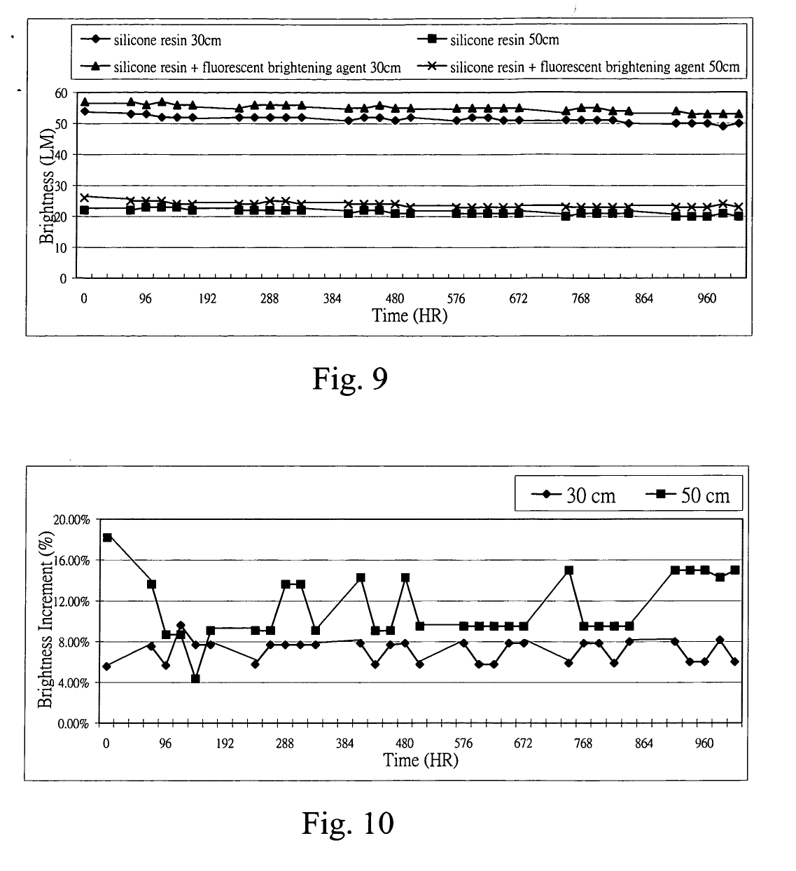

By using the same method for measuring the brightness as in EXAMPLE 1, the brightness (LM) of the blue light, emitted from GaN LED chip, after passing through a transparent encapsulation layer made of 3-(4-chlorophenyl)pyrazoline-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 9. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 9.

By using the same calculation method as in Example 1, the brightness increment percentages at the height of 30 cm, and 50 cm are calculated from the data given in FIG. 9, respectively, and the results are plotted in FIG. 10. The brightness is increased in average by 7.09% at the height of 30 cm, and the brightness is increased in average by 11.24% % at the height of 50 cm. Therefore, if the transparent resin encapsulation layer used for encapsulating LED chip contains a trace amount of 3-(4-chlorophenyl)pyrazoline as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 6

The light-enhanced LED device is fabricated by the same method as in EXAMPLE 1 except that pyrazoline is used as a fluorescent brightening agent instead of stilbene. The conventional LED device fabricated in EXAMPLE 1 is used. The pyrazoline structure is shown as following: 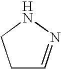
Brightness Test

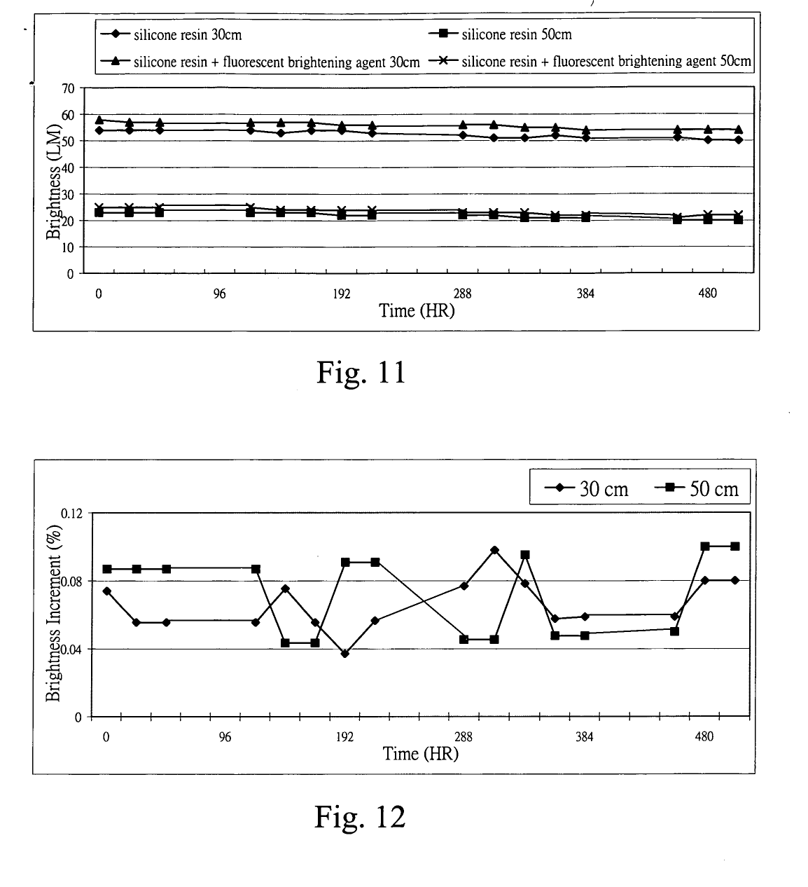

By using the same method for measuring the brightness as in EXAMPLE 1, the brightness (LM) of the blue light, emitted from GaN LED chip, after passing through a transparent encapsulation layer made of pyrazoline-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 11. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 11.

By using the same calculation method as in Example 1, the brightness increment percentages at the height of 30 cm, and 50 cm are calculated from the data given in FIG. 11, respectively, and the results are plotted in FIG. 12. The brightness is increased in average by 6.59% at the height of 30 cm, and the brightness is increased in average by 7.17% at the height of 50 cm. Therefore, if the transparent resin encapsulation layer used for encapsulating LED chip contains a trace amount of pyrazoline as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 7

The light-enhanced LED device is fabricated by the same method as in EXAMPLE 1 except that imidazole is used as a fluorescent brightening agent instead of stilbene. The conventional LED device fabricated in EXAMPLE 1 is used. The imidazole structure is shown as following: 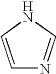
Brightness Test

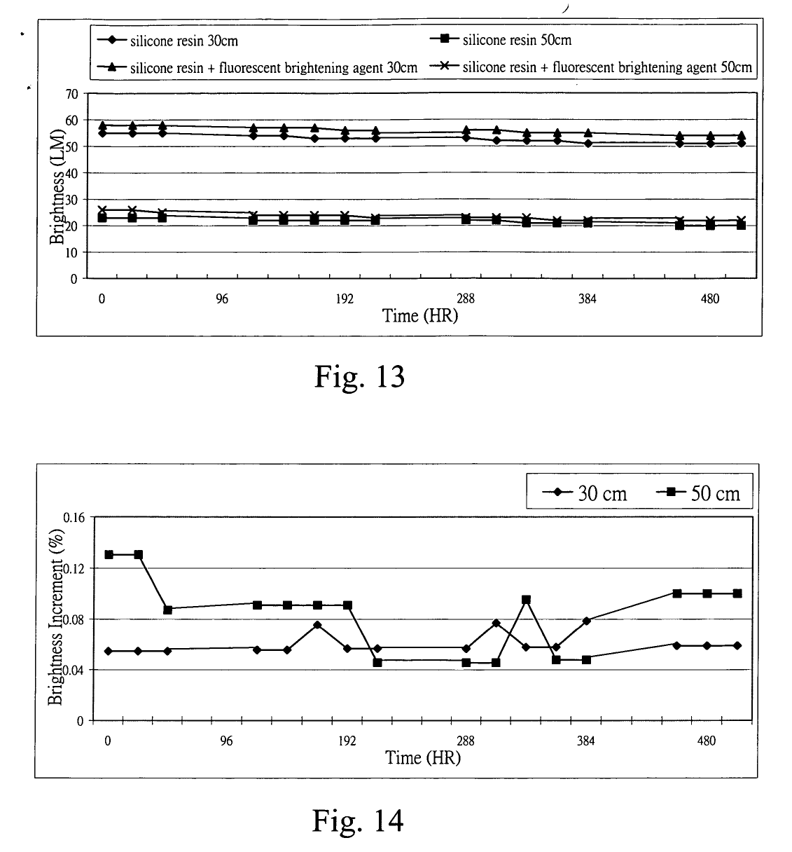

By using the same method for measuring the brightness as in EXAMPLE 1, the brightness (LM) of the blue light, emitted from GaN LED chip, after passing through a transparent encapsulation layer made of imidazole-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 13. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 13.

By using the same calculation method as in Example 1, the brightness increment percentages at the height of 30 cm, and 50 cm are calculated from the data given in FIG. 13, respectively, and the results are plotted in FIG. 14. The brightness is increased in average by 6.05% at the height of 30 cm, and the brightness is increased in average by 8.36% at the height of 50 cm. Therefore, if the transparent resin encapsulation layer used for encapsulating LED chip contains a trace amount of imidazole as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 8

The light-enhanced LED device is fabricated by the same method as in EXAMPLE 1 except that 1,2,4-triazole is used as a fluorescent brightening agent instead of stilbene. The conventional LED device fabricated in EXAMPLE 1 is used. The 1,2,4-triazole structure is shown as following: 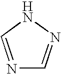
Brightness Test

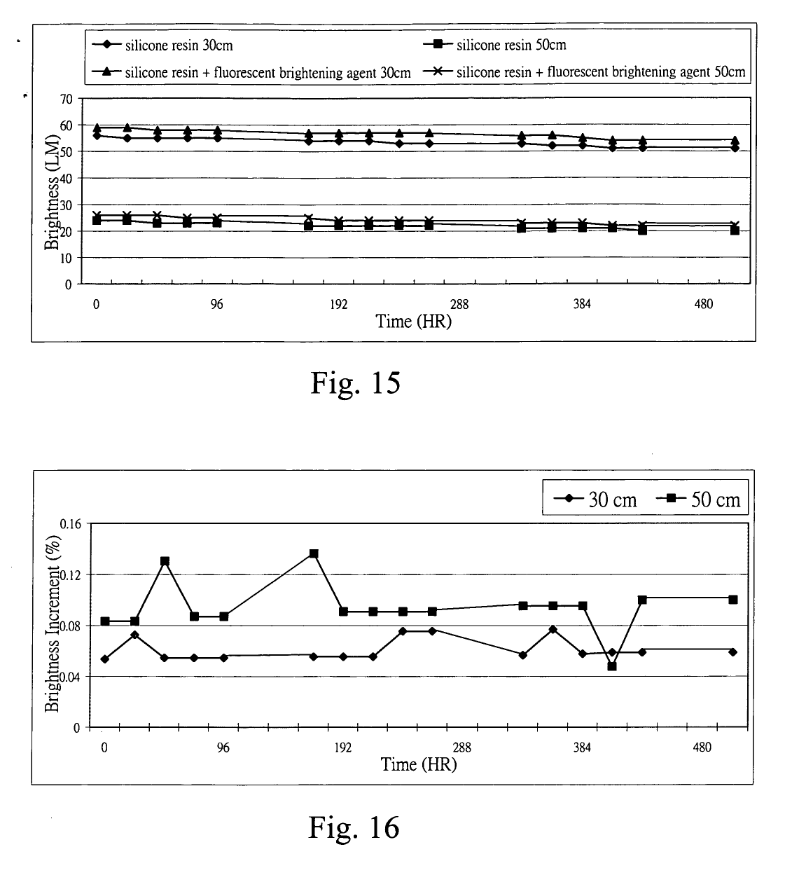

By using the same method for measuring the brightness as in EXAMPLE 1, the brightness (LM) of the blue light, emitted from GaN LED chip, after passing through a transparent encapsulation layer made of 1,2,4-triazole-silicone resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 15. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 15.

By using the same calculation method as in Example 1, the brightness increment percentages at the height of 30 cm, and 50 cm are calculated from the data given in FIG. 15, respectively, and the results are plotted in FIG. 16. The brightness is increased in average by 6.10% at the height of 30 cm, and the brightness is increased in average by 9.40% at the height of 50 cm. Therefore, if the transparent resin encapsulation layer used for encapsulating LED chip contains a trace amount of 1,2,4-triazole as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 9

The light-enhanced LED device is fabricated by the same method as in EXAMPLE 1 except that oxazolidine-2-one is used as a fluorescent brightening agent instead of stilbene. The conventional LED device fabricated in EXAMPLE 1 is used. The oxazolidine-2-one structure is shown as following: 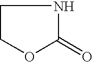
Brightness Test

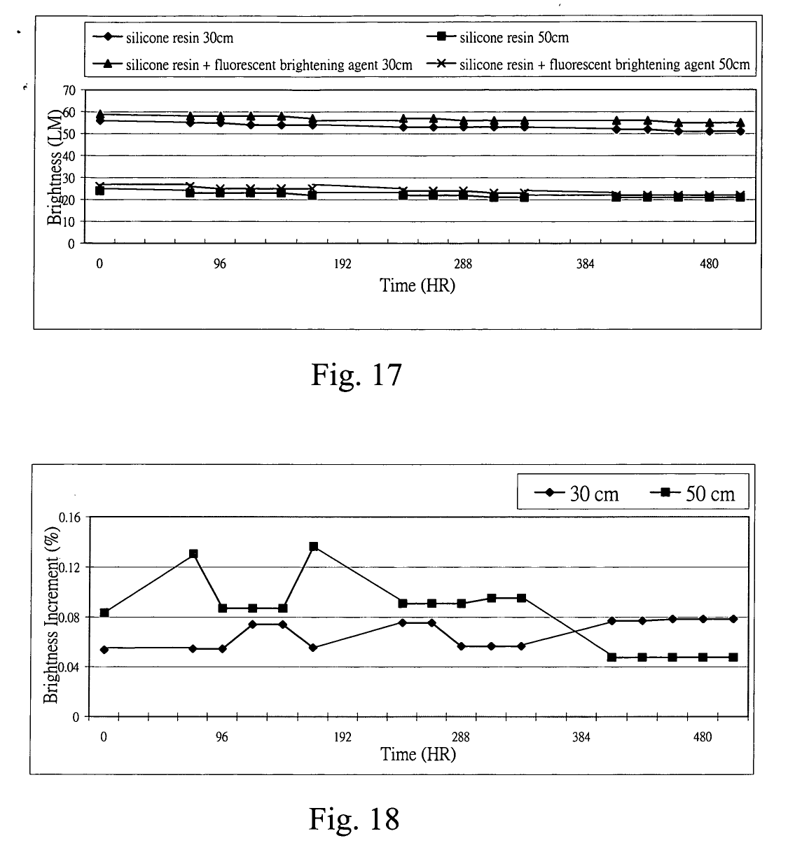

By using the same method for measuring the brightness as in EXAMPLE 1, the brightness (LM) of the blue light, emitted from GaN LED chip, after passing through a transparent encapsulation layer made of oxazolidine-2-one-resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 17. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 17.

By using the same calculation method as in Example 1, the brightness increment percentages at the height of 30 cm, and 50 cm are calculated from the data given in FIG. 17, respectively, and the results are plotted in FIG. 18. The brightness is increased in average by 6.73% at the height of 30 cm, and the brightness is increased in average by 8.20% at the height of 50 cm. Therefore, if the transparent resin encapsulation layer used for encapsulating LED chip contains a trace amount of oxazolidine-2-one as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 10

The light-enhanced LED device is fabricated by the same method as in EXAMPLE 1 except that 1,8-naphthyl-imide is used as a fluorescent brightening agent instead of stilbene. The conventional LED device fabricated in EXAMPLE 1 is used. The 1,8-naphthyl-imide structure is shown as following: 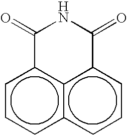
Brightness Test

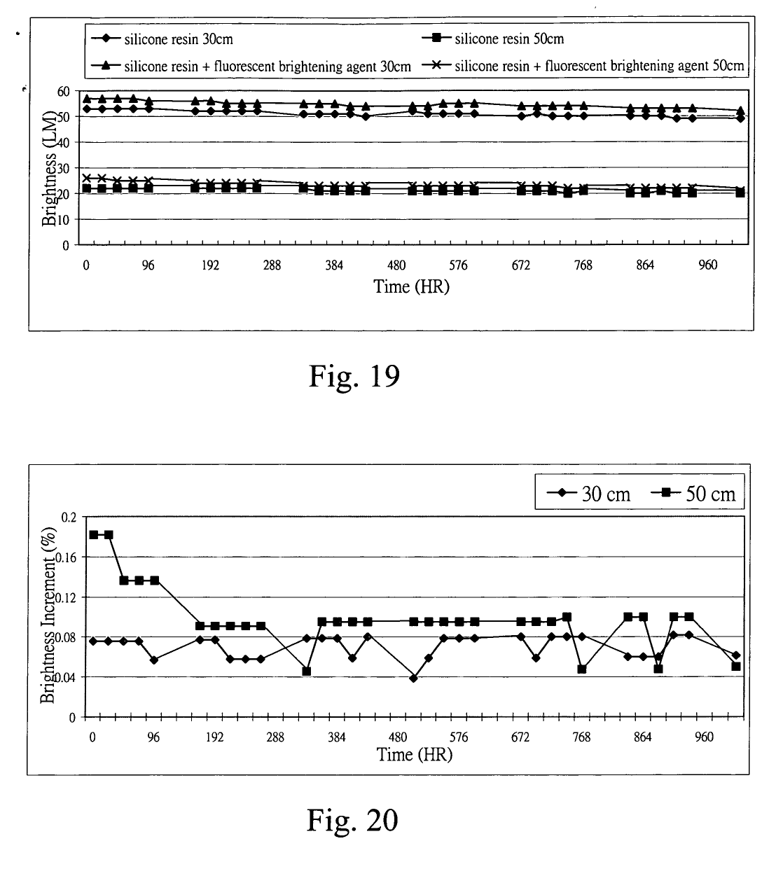

By using the same method for measuring the brightness as in EXAMPLE 1, the brightness (LM) of the blue light, emitted from GaN LED chip, after passing through a transparent encapsulation layer made of 1,8-naphthyl-imide-resin mixture and undergoing wavelength conversion is measured by Illuminance Meter at the height of 30 cm, and 50 cm every 24 hours, respectively, until the total measured time reaches a setting value of 960 hours. The measurement results are shown in FIG. 19. Likewise, the brightness (LM) of the blue light with a wavelength of about 465 nm, emitted from GaN LED chip, after passing through a transparent encapsulation layer made of pure silicone resin is measured by Illuminance Meter at the height of 30 cm, and 50 cm every 24 hours, respectively, until the total measured time reaches a setting value of 960 hours. The measurement results are also shown in FIG. 19.

By using the same calculation method as in Example 1, the brightness increment percentages at the height of 30 cm, and 50 cm are calculated from the data given in FIG. 19, respectively, and the results are plotted in FIG. 20. The brightness is increased in average by 7.02% at the height of 30 cm, and the brightness is increased in average by 9.87% at the height of 50 cm. Therefore, if the transparent resin encapsulation layer used for encapsulating LED chip contains a trace amount of 1,8-naphthyl-imide as a fluorescent brightening agent, the brightness of light emitted from LED chip will be greatly enhanced after passing through such a transparent resin encapsulation layer, and thereby the problems of color spots (such as black or yellow spots) and halo phenomena occurred in the conventional LED can be eliminated. Moreover, no light decay was observed during 960 hours in this embodiment.

### EXAMPLE 11

The light-enhanced acrylic plate as a light guide plate in a backlight module is fabricated by mixing 0.01% by weight of 4,4′-bis(2-methoxystyryl)-1,1′-biphenyl used as a fluorescent brightening agent with 99.99% by weight of transparent acrylic resin, and followed by injection molding processing and being cut into 32 mm by 12 mm in size. In addition, a conventional acrylic plate as a light guide plate in a backlight module is fabricated by injection molding a transparent acrylic resin and followed by being cut into 32 mm by 12 mm in size. The 4,4′-bis(2-methoxystyryl)-1,1′-biphenyl structure is shown as following: 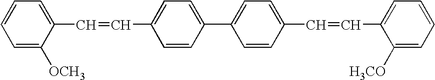
Brightness Test

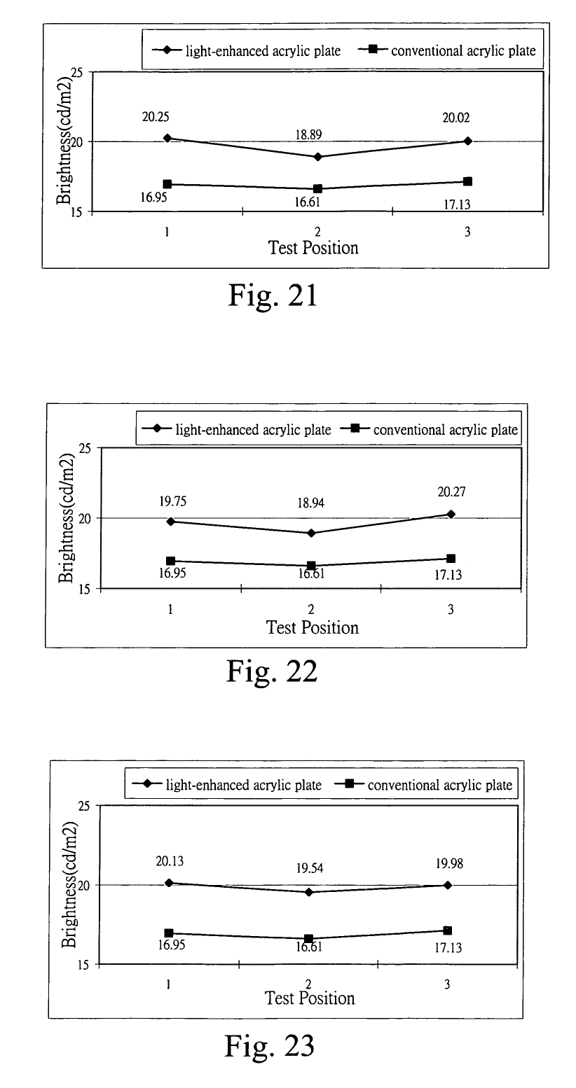

The blue LEDs illuminate the light-enhanced acrylic plate containing 4,4′-bis(2-methoxystyryl)-1,1′-biphenyl from the left and right sides thereof. The brightnesses (cd/m²) of three test spots located on the light-enhanced acrylic plate are measured at a distance of one meter from this plate using a BM-7 luminance meter, wherein the three test spots are located on the center, 10 mm from the left side, and 10 mm from the right side of the light-enhanced acrylic plate, respectively. The results of brightness measurement made on the three test spots of the light-enhanced acrylic plate are shown in FIG. 21. Likewise, the blue LEDs illuminate the conventional acrylic plate not containing 4,4′-bis(2-methoxystyryl)-1,1′-biphenyl from the left and right sides thereof. The brightnesses (cd/m²) of three test spots on the conventional acrylic plate are measured at a distance of one meter from this plate using a BM-7 luminance meter, wherein the three test spots are also located on the center, 10 mm from the left side, and 10 mm from the right side of the conventional acrylic plate, respectively. The results of brightness measurement made on the three test spots of the conventional acrylic plate are also shown in FIG. 21. The brightnesses of the three test spots on the light-enhanced acrylic plate are increased in average by 16.69% as compared with the brightnesses of the three test spots on the conventional acrylic plate upon illumination. Therefore, if the acrylic plate used as a light guide plate in a backlight module contains a trace amount of 4,4′-bis(2-methoxystyryl)-1,1′-biphenyl as a fluorescent brightening agent, the brightness of the panel display device with this light-enhanced acrylic plate will be greatly enhanced upon illumination by the light source.

### EXAMPLE 12

The light-enhanced acrylic plate is fabricated by the same method as in EXAMPLE 11 except that 4,4′-bis{2-(1-pyrenyl)ethenyl}-1,1′-biphenyl is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4′-bis{2-(1-pyrenyl)ethenyl}-1,1′-biphenyl structure is shown as following: 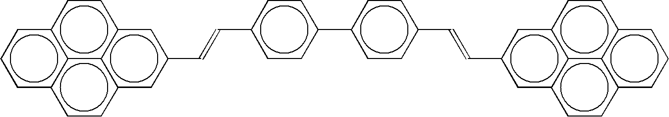
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 22. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 22. The brightnesses of the three test spots on the light-enhanced acrylic plate are increased in average by 16.29% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4′-bis[2-(1-pyrenyl)ethenyl]-1,1′-biphenyl as a fluorescent brightening agent, the brightness of the panel display device with this light-enhanced acrylic plate will be greatly enhanced upon illumination by the light source.

### EXAMPLE 13

The light-enhanced acrylic plate is fabricated by the same method as in EXAMPLE 11 except that 4,4′-bis{2-(9-phenanthrenyl)ethenyl}-1,1′-biphenyl is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4′-bis{2-(9-phenanthrenyl)ethenyl}-1,1′-biphenyl structure is shown as following: 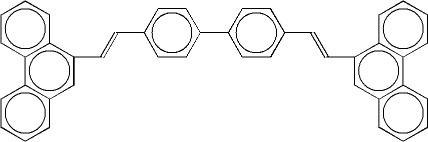
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 23. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 23. The brightnesses of the three test spots on the light-enhanced acrylic plate are increased in average by 17.68% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4′-bis{2-(9-phenanthrenyl)ethenyl}-1,1′-biphenyl as a fluorescent brightening agent, the brightness of the panel display device with this light-enhanced acrylic plate will be greatly enhanced upon illumination by the light source.

### EXAMPLE 14

The light-enhanced acrylic plate is fabricated by the same method as in EXAMPLE 11 except that 4,4′-bis{2-(9-anthracenyl)ethenyl}-1,1′-biphenyl is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4′-bis{2-(9-anthracenyl)ethenyl}-1,1′-biphenyl structure is shown as following: 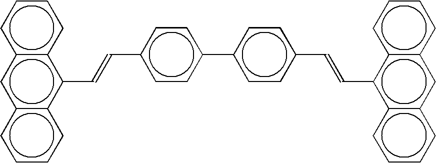
Brightness Test

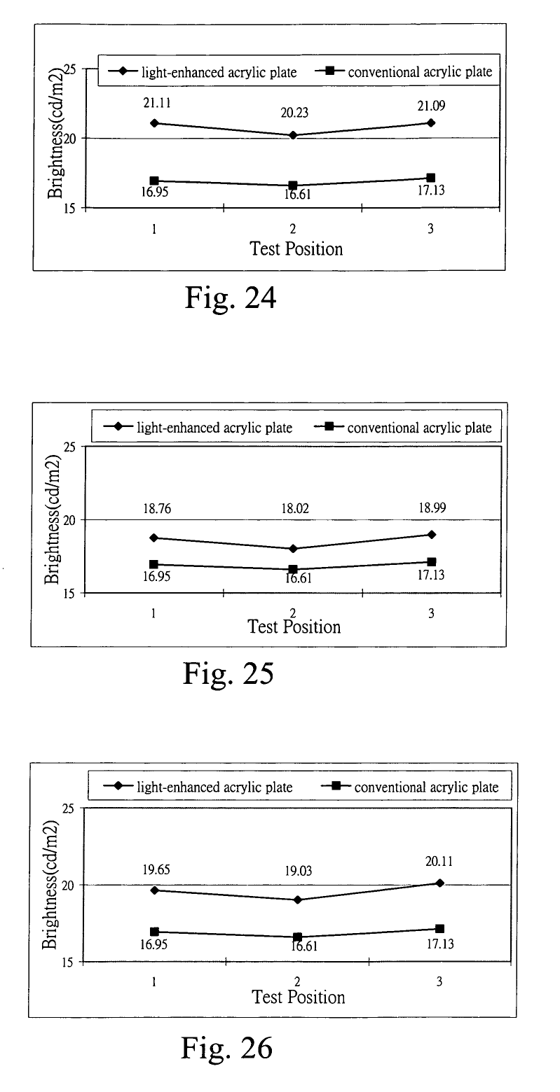

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 24. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 24. The brightnesses of the three test spots on the light-enhanced acrylic plate are increased in average by 23.15% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4′-bis{2-(9-anthracenyl)ethenyl}-1,1′-biphenyl as a fluorescent brightening agent, the brightness of the panel display device with this light-enhanced acrylic plate will be greatly enhanced upon illumination by the light source.

### EXAMPLE 15

The light-enhanced acrylic plate is fabricated by the same method as in EXAMPLE 11 except that 4,4′-bis{2-(1-anthraquinonyl)ethenyl}-1,1′-biphenyl is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4′-bis{2-(1-anthraquinonyl)ethenyl}-1,1′-biphenyl structure is shown as following: 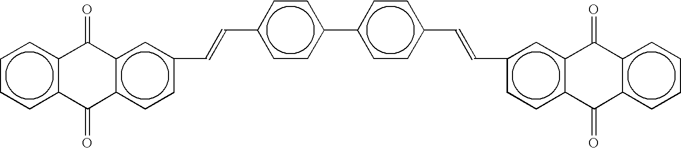
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 25. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 25. The brightnesses of the three test spots on the light-enhanced acrylic plate are increased in average by 10.01% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4′-bis{2-(1-anthraquinonyl)ethenyl}-1,1′-biphenyl as a fluorescent brightening agent, the brightness of the panel display device with this light-enhanced acrylic plate will be greatly enhanced upon illumination by the light source.

### EXAMPLE 16

The light-enhanced acrylic plate is fabricated by the same method as in EXAMPLE 11 except that 4,4′-bis{2-(2-fluorenyl)ethenyl}-1,1′-biphenyl is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4′-bis{2-(2-fluorenyl)ethenyl}-1,1′-biphenyl structure is shown as following: 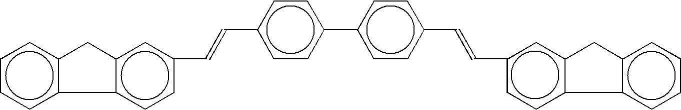
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 26. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 26. The brightnesses of the three test spots on the light-enhanced acrylic plate are increased in average by 15.97% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4′-bis{2-(2-fluorenyl)ethenyl}-1,1′-biphenyl as a fluorescent brightening agent, the brightness of the panel display device with this light-enhanced acrylic plate will be greatly enhanced upon illumination by the light source.

### EXAMPLE 17

The light-enhanced acrylic plate is fabricated by the same method as in EXAMPLE 11 except that 1,4-bis(2-cyanostyryl)benzene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 1,4-bis(2-cyanostyryl)benzene structure is shown as following: 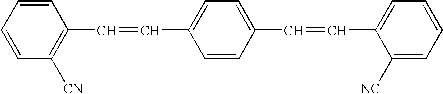
Brightness Test

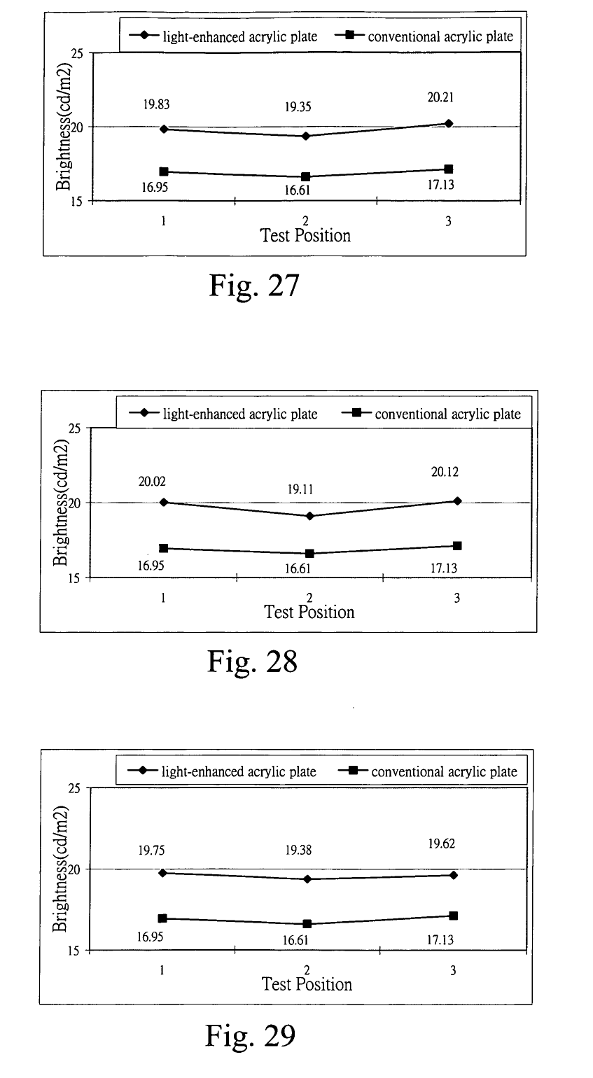

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 27. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 27. The brightnesses of the three test spots on the light-enhanced acrylic plate are increased in average by 17.16% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 1,4-bis(2-cyanostyryl)benzene as a fluorescent brightening agent, the brightness of the panel display device with this light-enhanced acrylic plate will be greatly enhanced upon illumination by the light source.

### EXAMPLE 18

The light-enhanced acrylic plate is fabricated by the same method as in EXAMPLE 11 except that 1,4-bis(2-benzoxazoly)naphthalene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 1,4-bis(2-benzoxazoly)naphthalene structure is shown as following: 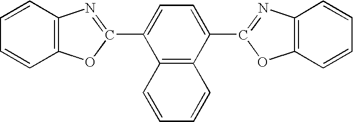
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 28. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 28. The brightnesses of the three test spots on the light-enhanced acrylic plate are increased in average by 16.87% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 1,4-bis(2-benzoxazoly)naphthalene as a fluorescent brightening agent, the brightness of the panel display device with this light-enhanced acrylic plate will be greatly enhanced upon illumination by the light source.

### EXAMPLE 19

The light-enhanced acrylic plate is fabricated by the same method as in EXAMPLE 11 except that 2,5-bis(5-tertbutyl-2-benzoxazolyl)thiophene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 2,5-bis(5-tertbutyl-2-benzoxazolyl)thiophene structure is shown as following: 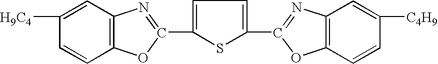
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 29. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 29. The brightnesses of the three test spots on the light-enhanced acrylic plate are increased in average by 15.91% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 2,5-bis(5-tertbutyl-2-benzoxazolyl)thiophene as a fluorescent brightening agent, the brightness of the panel display device with this light-enhanced acrylic plate will be greatly enhanced upon illumination by the light source.

### EXAMPLE 20

The light-enhanced acrylic plate is fabricated by the same method as in EXAMPLE 11 except that 2,5-bis(2-benzoxazolyl)thiophene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 2,5-bis(2-benzoxazolyl)thiophene structure is shown as following: 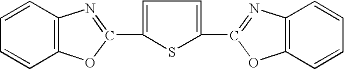
Brightness Test

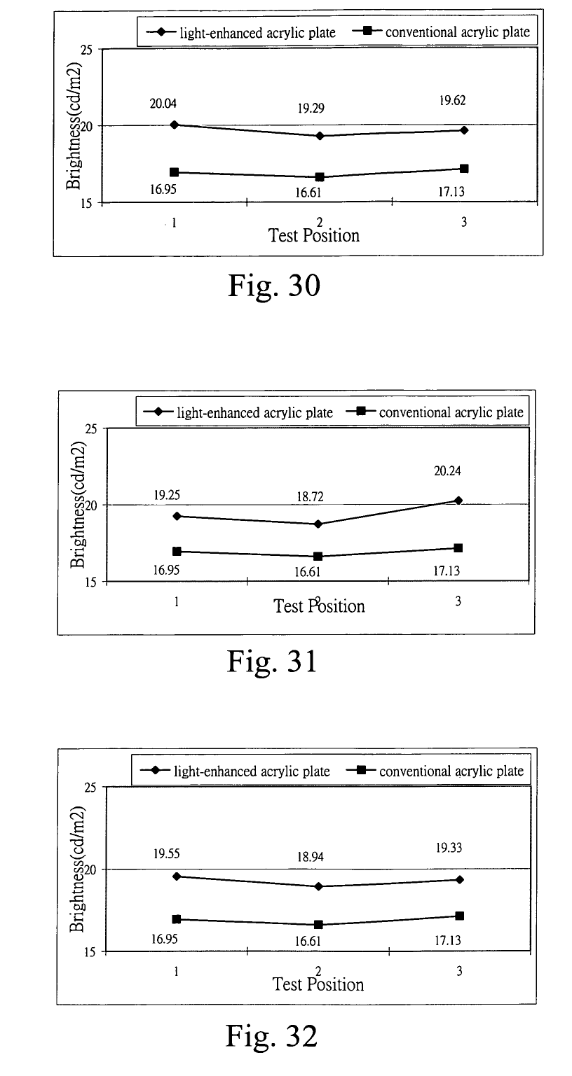

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 30. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 30. The brightnesses of the three test spots on the light-enhanced acrylic plate are increased in average by 16.30% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 2,5-bis(2-benzoxazolyl)thiophene as a fluorescent brightening agent, the brightness of the panel display device with this light-enhanced acrylic plate will be greatly enhanced upon illumination by the light source.

### EXAMPLE 21

The light-enhanced acrylic plate is fabricated by the same method as in EXAMPLE 11 except that 4,4-bis(benzoxazoyl)stilbene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4-bis(benzoxazoyl)stilbene structure is shown as following: 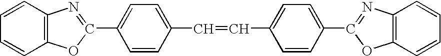
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 31. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 31. The brightnesses of the three test spots on the light-enhanced acrylic plate are increased in average by 14.81% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4-bis(benzoxazoyl)stilbene as a fluorescent brightening agent, the brightness of the panel display device with this light-enhanced acrylic plate will be greatly enhanced upon illumination by the light source.

### EXAMPLE 22

The light-enhanced acrylic plate is fabricated by the same method as in EXAMPLE 11 except that 4,4′-bis(5-methyl-2-benzoxazolyl)stilbene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4,4′-bis(5-methyl-2-benzoxazolyl)stilbene structure is shown as following: 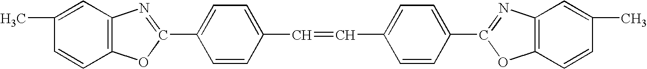
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 32. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 32. The brightnesses of the three test spots on the light-enhanced acrylic plate are increased in average by 14.07% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4,4′-bis(5-methyl-2-benzoxazolyl)stilbene as a fluorescent brightening agent, the brightness of the panel display device with this light-enhanced acrylic plate will be greatly enhanced upon illumination by the light source.

### EXAMPLE 23

The light-enhanced acrylic plate is fabricated by the same method as in EXAMPLE 11 except that 1,2-bis(5-methyl-2-benzoxazolyl)ethylene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 1,2-bis(5-methyl-2-benzoxazolyl)ethylene structure is shown as following: 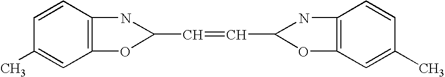
Brightness Test

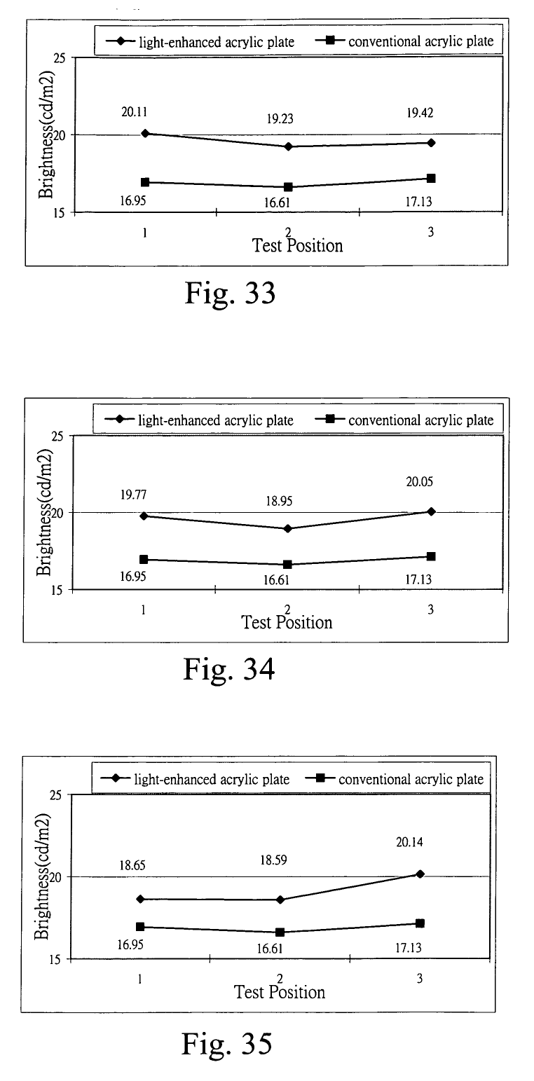

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 33. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 33. The brightnesses of the three test spots on the light-enhanced acrylic plate are increased in average by 15.93% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 1,2-bis(5-methyl-2-benzoxazolyl)ethylene as a fluorescent brightening agent, the brightness of the panel display device with this light-enhanced acrylic plate will be greatly enhanced upon illumination by the light source.

### EXAMPLE 24

The light-enhanced acrylic plate is fabricated by the same method as in EXAMPLE 11 except that ethyl 5,6-benzocoumarin-3-carboxylate is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The ethyl 5,6-benzocoumarin-3-carboxylate structure is shown as following: 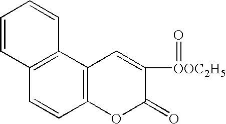
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 34. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 34. The brightnesses of the three test spots on the light-enhanced acrylic plate are increased in average by 15.92% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of ethyl 5,6-benzocoumarin-3-carboxylate as a fluorescent brightening agent, the brightness of the panel display device with this light-enhanced acrylic plate will be greatly enhanced upon illumination by the light source.

### EXAMPLE 25

The light-enhanced acrylic plate is fabricated by the same method as in EXAMPLE 11 except that 3-phenyl-5,6-benzocoumarin is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 3-phenyl-5,6-benzocoumarin structure is shown as following: 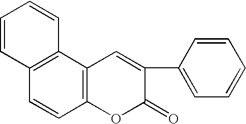
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 35. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 35. The brightnesses of the three test spots on the light-enhanced acrylic plate are increased in average by 13.17% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 3-phenyl-5,6-benzocoumarin as a fluorescent brightening agent, the brightness of the panel display device with this light-enhanced acrylic plate will be greatly enhanced upon illumination by the light source.

### EXAMPLE 26

The light-enhanced acrylic plate is fabricated by the same method as in EXAMPLE 11 except that N-methyl-4,5-diethoxy-1,8-naphthyl-imide is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The N-methyl-4,5-diethoxy-1,8-naphthyl-imide structure is shown as following: 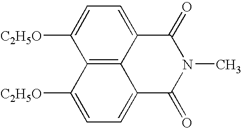
Brightness Test

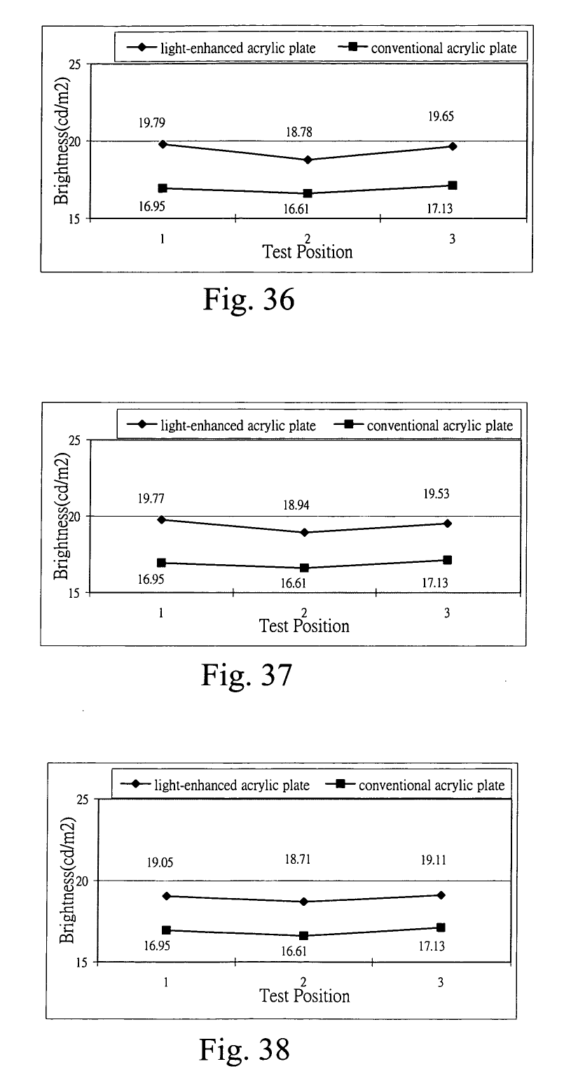

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 36. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 36. The brightnesses of the three test spots on the light-enhanced acrylic plate are increased in average by 14.84% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of N-methyl-4,5-diethoxy-1,8-naphthyl-imide as a fluorescent brightening agent, the brightness of the panel display device with this light-enhanced acrylic plate will be greatly enhanced upon illumination by the light source.

### EXAMPLE 27

The light-enhanced acrylic plate is fabricated by the same method as in EXAMPLE 11 except that N-methyl-4-methoxy-1,8-naphthyl-imide is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The N-methyl-4-methoxy-1,8-naphthyl-imide structure is shown as following: 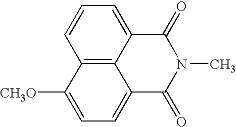
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 37. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 37. The brightnesses of the three test spots on the light-enhanced acrylic plate are increased in average by 14.89% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of N-methyl-4-methoxy-1,8-naphthyl-imide as a fluorescent brightening agent, the brightness of the panel display device with this light-enhanced acrylic plate will be greatly enhanced upon illumination by the light source.

### EXAMPLE 28

The light-enhanced acrylic plate is fabricated by the same method as in EXAMPLE 11 except that 3-(4-chlorophenyl)-1,5-diphenyl-2-pyrazoline is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 3-(4-chlorophenyl)-1,5-diphenyl-2-pyrazoline structure is shown as following: 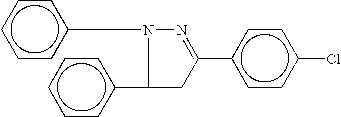
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 38. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 38. The brightnesses of the three test spots on the light-enhanced acrylic plate are increased in average by 12.20% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 3-(4-chlorophenyl)-1,5-diphenyl-2-pyrazoline as a fluorescent brightening agent, the brightness of the panel display device with this light-enhanced acrylic plate will be greatly enhanced upon illumination by the light source.

### EXAMPLE 29

The light-enhanced acrylic plate is fabricated by the same method as in EXAMPLE 11 except that 3-(4-chlorophenyl)-1-phenyl-pyrazole is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 3-(4-chlorophenyl)-1-phenyl-pyrazole structure is shown as following: 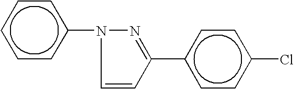
Brightness Test

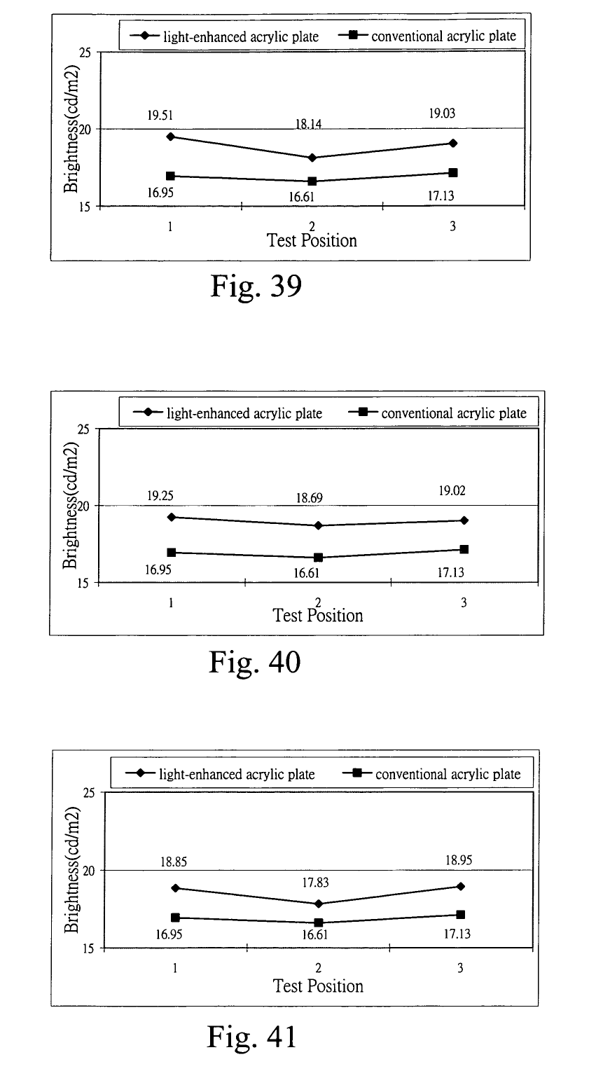

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 39. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 39. The brightnesses of the three test spots on the light-enhanced acrylic plate are increased in average by 11.80% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 3-(4-chlorophenyl)-1-phenyl-pyrazole as a fluorescent brightening agent, the brightness of the panel display device with this light-enhanced acrylic plate will be greatly enhanced upon illumination by the light source.

### EXAMPLE 30

The light-enhanced acrylic plate is fabricated by the same method as in EXAMPLE 11 except that 4-methyl-7-diethylaminocoumarin is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 4-methyl-7-diethylaminocoumarin structure is shown as following: 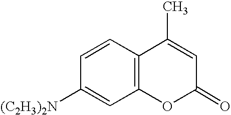
Brightness Test

By using the same method for measuring the brightnesses on the surface of the light-enhanced acrylic plate and on the surface of the conventional acrylic plate as in EXAMPLE 11, the brightnesses (cd/m) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 40. Likewise, the brightnesses (cd/m) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 40. The brightnesses of the three test spots on the light-enhanced acrylic plate are increased in average by 12.38% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 4-methyl-7-diethylaminocoumarin as a fluorescent brightening agent, the brightness of the panel display device with this light-enhanced acrylic plate will be greatly enhanced upon illumination by the light source.

### EXAMPLE 31

The light-enhanced acrylic plate is fabricated by the same method as in EXAMPLE 11 except that 1-(p-methanesulfonylphenyl)-3-(p-chlorophenyl)-2-pyrazoline is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 1-(p-methanesulfonylphenyl)-3-(p-chlorophenyl)-2-pyrazoline is shown as following: 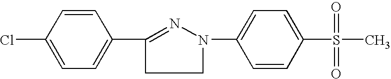
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 41. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 41. The brightnesses of the three test spots on the light-enhanced acrylic plate are increased in average by 9.73% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 1-(p-methanesulfonylphenyl)-3-(p-chlorophenyl)-2-pyrazoline as a fluorescent brightening agent, the brightness of the panel display device with this light-enhanced acrylic plate will be greatly enhanced upon illumination by the light source.

### EXAMPLE 32

The light-enhanced acrylic plate is fabricated by the same method as in EXAMPLE 11 except that 1-(p-sulfonamidophenyl)-3-(p-chlorophenyl)-2-pyrazoline is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The 1-(p-sulfonamidophenyl)-3-(p-chlorophenyl)-2-pyrazoline is shown as following: 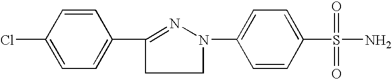
Brightness Test

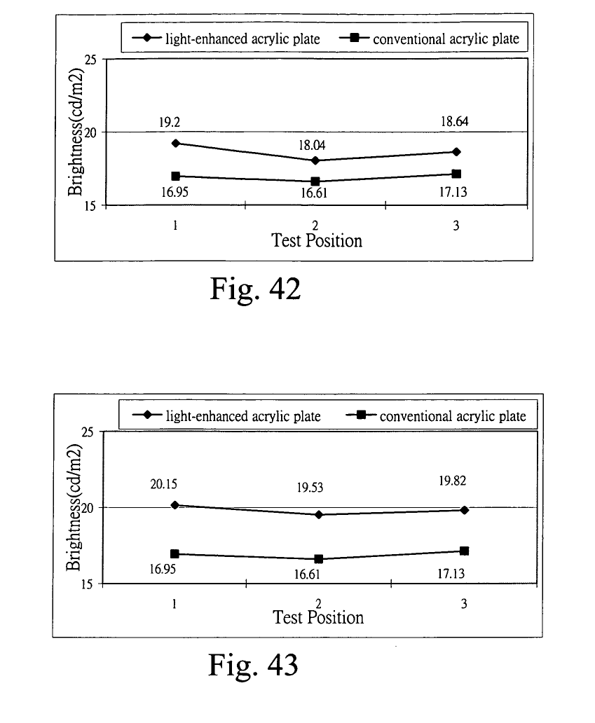

By using the same method for measuring the brightnesses on the surface of the light-enhanced acrylic plate and on the surface of the conventional acrylic plate as in EXAMPLE 11, the brightnesses (cd/m) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 42. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 42. The brightnesses of the three test spots on the light-enhanced acrylic plate are increased in average by 10.23% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of 1-(p-sulfonamidophenyl)-3-(p-chlorophenyl)-2-pyrazoline as a fluorescent brightening agent, the brightness of the panel display device with this light-enhanced acrylic plate will be greatly enhanced upon illumination by the light source.

### EXAMPLE 33

The light-enhanced acrylic plate is fabricated by the same method as in EXAMPLE 11 except that pyrene is used as a fluorescent brightening agent instead of 4,4′-bis(2-methoxystyryl)-1,1′-biphenyl. The conventional acrylic plate fabricated in EXAMPLE 11 is used in this embodiment. Both the light-enhanced acrylic plate and the conventional acrylic plate are 32 mm by 12 mm in size. The pyrene is shown as following: 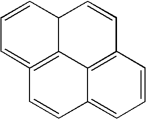
Brightness Test

By using the same method for measuring the brightnesses on the surface of the light-enhanced acrylic plate and on the surface of the conventional acrylic plate as in EXAMPLE 11, the brightnesses (cd/m²) of the three test spots on the light-enhanced acrylic plate (located at the same positions as the three test spots on the light-enhanced acrylic plate described in EXAMPLE 11) are measured at a distance of one meter from this plate using a BM-7 luminance meter. The results of brightness measurement made on the three test spots of the light-enhanced acrylic plate are shown in FIG. 43. Likewise, the brightnesses (cd/m²) of the three test spots on the conventional acrylic plate (located at the same positions as the three test spots on the conventional acrylic plate described in EXAMPLE 11) are measured at a distance of one meter from this plate using a BM-7 luminance meter. The results of brightness measurement made on the three test spots of the conventional acrylic plate are also shown in FIG. 43. The brightnesses of the three test spots on the light-enhanced acrylic plate are increased in average by 17.39% as compared with the brightnesses of the three test spots on the conventional acrylic plate (located at the same positions as those on the light-enhanced acrylic plate) upon illumination. Therefore, if the acrylic plate used as a light guide plate in a backlight module contains a trace amount of pyrene as a fluorescent brightening agent, the brightness of the panel display device with this light-enhanced acrylic plate will be greatly enhanced upon illumination by the light source.

### EXAMPLE 34

The light-enhanced LED device is fabricated by the following procedures: (a) dispensing an epoxy resin, which contains YAG:Ce (cerium) phosphor emitting a yellow light (wavelength: 560 nm), on a blue InGaN-based LED placed on the reflection cup; (b) connecting an electrode line to the LED; and (c) surrounding and sealing the LED with an epoxy resin containing a trace amount of 4,4′-bis(2-methoxystyryl)-1,1′-biphenyl as a fluorescent brightening agent. In this light-enhanced LED device, the epoxy resin is present in an amount of from 89.95% by weight of total weight of the resin composition for the encapsulation layer, the YAG:Ce (cerium) phosphor is present in an amount of 10% by weight of total weight of the resin composition for the encapsulation layer, and 4,4′-bis(2-methoxystyryl)-1,1′-biphenyl is present in an amount of from 0.05% by weight of total weight of the resin composition for the encapsulation layer. The conventional LED device is fabricated by the following procedures: (a) dispensing an epoxy resin, which contains YAG:Ce (cerium) phosphor emitting a yellow light (wavelength: 560 nm), on a blue InGaN-based LED placed on the reflection cup; (b) connecting an electrode line to the LED; and (c) surrounding and sealing the LED with pure epoxy resin. In this conventional LED device, the epoxy resin is present in an amount of from 90% by weight of total weight of the resin composition for the encapsulation layer, and the YAG:Ce (cerium) phosphor is present in an amount of 10% by weight of total weight of the resin composition for the encapsulation layer.

Brightness Test

The above-fabricated light-enhanced LED device and the conventional LED device are placed in the interior of an integrating sphere, respectively, and each LED device is illuminated when subjected to a voltage of 3.6 V The brightnesses (cd) and color temperatures (° K) of the light-enhanced LED device and the conventional LED device are measured by MFS-230 Fluorescence Spectrometer, respectively. The measurements are repeated nine times for each LED device, and the measured results are listed in Table 1 and Table 2, respectively.

TABLE 1
Light-Enhanced LED Device

| Measurement | Brightnesses (cd) | Color temperatures (° K) |
|---|---|---|
| 1st | 2.485 | 5595.859 |
| 2nd | 2.431 | 5086.081 |
| 3rd | 2.259 | 5270.947 |
| 4th | 2.193 | 5015.032 |
| 5th | 2.012 | 5391.976 |
| 6th | 2.601 | 5137.113 |
| 7th | 2.227 | 5045.665 |
| 8th | 2.231 | 5307.471 |
| 9th | 2.579 | 5434.015 |
| average | 2.335 | 5253.795 |

TABLE 2
Conventional LED Device

| Measurement | Brightnesses (cd) | Color temperatures (° K) |
|---|---|---|
| 1st | 1.957 | 5778.094 |
| 2nd | 1.764 | 6176.262 |
| 3rd | 2.064 | 6063.969 |
| 4th | 2.011 | 5590.599 |
| 5th | 1.776 | 5703.527 |
| 6th | 1.642 | 5868.763 |
| 7th | 2.083 | 5308.633 |
| 8th | 1.746 | 5581.491 |
| 9th | 2.167 | 5455.118 |
| average | 1.9122 | 5725.162 |

As seen from Tables 1 and 2, the brightness of the light-enhanced LED device is increased in average by 22.13% as compared with the brightness of the conventional LED device upon illumination. Moreover, the average color temperature of the light-enhanced LED device is lower than that of the conventional LED device, and that means the light emitted from the light-enhanced LED device looks warmer than that emitted from the conventional LED device, and thus the human eyes will not be easily hurt.

### EXAMPLE 35

The light-enhanced LED device is fabricated by the same method as in EXAMPLE 11 except that 1,4-bis(2-benzoxazoly)naphthalene is used as a fluorescent brightening agent instead of 4,4′-bis(2-methoxystyryl)-1,1′-biphenyl. The conventional LED device fabricated in EXAMPLE 34 is used in this embodiment.

Brightness Test

The above-fabricated light-enhanced LED device and the conventional LED device are placed in the interior of an integrating sphere, respectively, and each LED device is illuminated when subjected to a voltage of 3.6 V The brightnesses (cd) and color temperatures (° K) of the light-enhanced LED device and the conventional LED device are measured by MFS-230 Fluorescence Spectrometer, respectively. The measurements are repeated nine times for each LED device, and the measured results are listed in Table 3 and Table 4, respectively.

TABLE 3
Light-Enhanced LED Device

| Measurement | Brightnesses (cd) | Color temperatures (° K) |
|---|---|---|
| 1st | 2.609 | 5501.449 |
| 2nd | 2.334 | 5156.061 |
| 3rd | 2.179 | 5004.087 |
| 4th | 2.405 | 5215.054 |
| 5th | 2.631 | 5377.989 |
| 6th | 2.317 | 5238.195 |
| 7th | 2.325 | 5033.515 |
| 8th | 2.431 | 5347.455 |
| 9th | 2.272 | 5209.554 |
| average | 2.389 | 5231.484 |

TABLE 4
Conventional LED Device

| Measurement | Brightnesses (cd) | Color temperatures (° K) |
|---|---|---|
| 1st | 1.957 | 5778.094 |
| 2nd | 1.764 | 6176.262 |
| 3rd | 2.064 | 6063.969 |
| 4th | 2.011 | 5590.599 |
| 5th | 1.776 | 5703.527 |
| 6th | 1.642 | 5868.763 |
| 7th | 2.083 | 5308.633 |
| 8th | 1.746 | 5581.491 |
| 9th | 2.167 | 5455.118 |
| average | 1.912 | 5725.162 |

As seen from Tables 3 and 4, the brightness of the light-enhanced LED device is increased in average by 24.94% as compared with the brightness of the conventional LED device upon illumination. Moreover, the average color temperature of the light-enhanced LED device is lower than that of the conventional LED device, and that means the light emitted from the light-enhanced LED device looks warmer than that emitted from the conventional LED device, and thus the human eyes will not be easily hurt.

It is to be understood that the fluorescent brightening agents discussed above are exemplary and not limiting. The fluorescent brightening agents used in the present invention can be any organic fluorescent brightening agents as long as they can substantially completely absorb the light having a wavelength between 250 nm and 470 nm, and subsequently re-emits it as a visible light.

In the conventional white LED device composed of InGaN blue LED chip and YAG:Ce, the brightness of the white LED device cannot be further increased even after applying more amount of YAG phosphors to the white LED device. That's because when a large enough amount of inorganic YAG phosphor particles is applied to the white LED device, these particles will aggregate together into large particles which can shield the light. However, according to the present invention, the brightness of the conventional LED devices can be increased by about 20% without changing the original design of the LED devices when only a trace amount of the fluorescent brightening agents which can be well-dissolved in the organic solvents is applied to the conventional white LED devices. Moreover, the fluorescent brightening agents of the present invention can be also applied to any light-emitting device for light enhancement. Therefore, huge amounts of energy can be saved by applying the fluorescent brightening agents of the present invention to the light-emitting device including the light-emitting element which can emit UV light, blue light, or any light including UV light, blue light, or combination thereof.

Conventionally, the panel display brightness is increased by increasing the brightness of the light source. However, according to the present invention, the panel display brightness can be greatly increased by just applying a trace amount of the fluorescent brightening agents to a light guide plate for a backlight module without changing the original design of the display device, and the panel display brightness can be increased by about 10 to 20%. Therefore, huge amounts of energy can be saved in global view.

According to the present invention, the light-enhanced element which is a transparent element including a fluorescent brightening agent has the advantages of: (1) only a trace amount of a fluorescent brightening agent is needed for greatly increasing the brightness of a light-emitting device or a panel display device with such a light-enhanced element while the original designs of these devices are unchanged; (2) huge amounts of energy can be saved in global view; (3) the light emitted from the light-emitting device with such a light-enhanced element will look warmer, and thus the human eyes will not be easily hurt; (4) no light decay for a light-emitting device with such a light-enhanced element is observed during use; (5) the fluorescent brightening agents used are environmental-friendly materials, and will not cause heavy metal pollution and harmful metal radiation problems; (6) a light-emitting device with such a light-enhanced element has better color rendering than that of a conventional light-emitting device due to more wavelengths involved; (7) the manufacture cost is low, and the operation is easy; and (8) the problems of color spots (such as black or yellow spots) and halo phenomena occurred in the conventional LED can be eliminated due to brightness enhancement.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. A light-enhanced element comprising a transparent element including a fluorescent brightening agent, wherein the fluorescent brightening agent is capable of absorbing part of a first light emitted from a light-emitting element, and subsequently emitting a second light having a wavelength longer than that of the first light.

2. The light-enhanced element as claimed in claim 1, wherein the fluorescent brightening agent is selected from the group consisting of stilbene, benzooxazole, 9-oxo-xanthene, N-methyl-1,8-naphthyl-imide, 3-(4-chlorophenyl)pyrazoline, pyrazoline, imidazole, 1,2,4-triazole, oxazolidine-2-one, 1,8-naphthyl-imide, 4,4′-bis(2-methoxystyryl)-1,1′-biphenyl, 4,4′-bis(2-(1-pyrenyl)ethenyl)-1,1′-biphenyl, 4,4′-bis(2-(9-phenanthrenyl)ethenyl)-1,1′-biphenyl, 4,4′-bis(2-(9-anthracenyl)ethenyl)-1,1′-biphenyl, 4,4′-bis(2-(1-anthraquinonyl)ethenyl)-1,1′-biphenyl, 4,4′-bis{2-(2-fluorenyl)ethenyl}-1,1′-biphenyl, 1,4-bis(2-cyanostyryl)benzene, 1,4-bis(2-benzoxazoly)naphthalene, 2,5-bis(5-tertbutyl-2-benzoxazolyl)thiophene, 2,5-bis(2-benzoxazolyl)thiophene, 4,4-bis(benzoxazoyl)stilbene, 4,4′-bis(5-methyl-2-benzoxazolyl)stilbene, 1,2-bis(5-methyl-2-benzoxazolyl)ethylene, ethyl 5,6-benzocoumarin-3-carboxylate, 3-phenyl-5,6-benzocoumarin, N-methyl-4,5-diethoxy-1,8-naphthyl-imide, N-methyl-4-methoxy-1,8-naphthyl-imide, 3-(4-chlorophenyl)-1,5-diphenyl-2-pyrazoline, 3-(4-chlorophenyl)-1-phenyl-pyrazole, 4-methyl-7-diethylaminocoumarin, 1-(p-methanesulfonylphenyl)-3-(p-chlorophenyl)-2-pyrazoline, 1-(p-sulfonamidophenyl)-3-(p-chlorophenyl)-2-pyrazoline, and pyrene.

3. The light-enhanced element as claimed in claim 1, wherein the fluorescent brightening agent is a stilbene-type fluorescent brightening agent.

4. The light-enhanced element as claimed in claim 1, wherein the fluorescent brightening agent is a distyrylbiphenyl-type fluorescent brightening agent.

5. The light-enhanced element as claimed in claim 1, wherein the fluorescent brightening agent is coated on the transparent element.

6. The light-enhanced element as claimed in claim 1, wherein the fluorescent brightening agent is contained in the transparent element.

7. The light-enhanced element as claimed in claim 1, wherein the light-emitting element is a LED chip.

8. The light-enhanced element as claimed in claim 1, wherein the light-emitting element is a fluorescent lamp.

9. The light-enhanced element as claimed in claim 1, wherein the first light has a wavelength between 250 nm and 470 nm.

10. The light-enhanced element as claimed in claim 1, wherein the second light has a wavelength between 380 nm and 660 nm.

11. The light-enhanced element as claimed in claim 1, wherein the transparent element is an encapsulation layer of a LED.

12. The light-enhanced element as claimed in claim 11, wherein the encapsulation layer is made of a resin composition including a transparent resin, and the fluorescent brightening agent.

13. The light-enhanced element as claimed in claim 12, wherein the transparent resin is an epoxy resin, or a silicone resin.

14. The light-enhanced element as claimed in claim 12, wherein the transparent resin is present in an amount of from 99.99 to 99.9% by weight of total weight of a resin composition for the encapsulation layer.

15. The light-enhanced element as claimed in claim 12, wherein the fluorescent brightening agent is present in an amount of from 0.01 to 0.1% by weight of total weight of the resin composition for the encapsulation layer.

16. The light-enhanced element as claimed in claim 1, wherein the transparent element is a light guide plate for a backlight module.

17. The light-enhanced element as claimed in claim 16, wherein the light guide plate is made of a resin composition including a acrylic resin, and the fluorescent brightening agent.

18. The light-enhanced element as claimed in claim 17, wherein the acrylic resin is present in an amount of from 99.99 to 99.95% by weight of total weight of the resin composition for the light guide plate.

19. The light-enhanced element as claimed in claim 17, wherein the fluorescent brightening agent is present in an amount of from 0.01 to 0.05% by weight of total weight of the resin composition for the light guide plate.

20. The light-enhanced element as claimed in claim 1, wherein the transparent element is a fluorescent light tube.

21. The light-enhanced element as claimed in claim 1, wherein the transparent element is a lampshade.

22. The light-enhanced element as claimed in claim 1, further comprises a photoluminescent phosphor capable of absorbing part of the first light emitted from the light-emitting element, and subsequently emitting a third light having a wavelength longer than that of the first light.

23. The light-enhanced element as claimed in claim 11, wherein the encapsulation layer is made of a resin composition including a transparent resin, the fluorescent brightening agent, and a photoluminescent phosphor capable of absorbing part of the first light emitted from the light-emitting element, and subsequently emitting a third light having a wavelength longer than that of the first light.

24. The light-enhanced element as claimed in claim 22, wherein the photoluminescent phosphor is YAG:Ce phosphor.

25. The light-enhanced element as claimed in claim 22, wherein the third light has a wavelength between 530 nm and 590 nm.

26. The light-enhanced element as claimed in claim 22, wherein the photoluminescent phosphor is coated on the transparent element.

27. The light-enhanced element as claimed in claim 22, wherein the photoluminescent phosphor is contained in the transparent element.

28. The light-enhanced element as claimed in claim 23, wherein the transparent resin is present in an amount of from 84.9 to 94.99% by weight of total weight of the resin composition for the encapsulation layer.

29. The light-enhanced element as claimed in claim 23, wherein the photoluminescent phosphor is present in an amount of from 5.00 to 15.00% by weight of total weight of the resin composition for the encapsulation layer.

30. The light-enhanced element as claimed in claim 23, wherein the fluorescent brightening agent is present in an amount of from 0.01 to 0.1% by weight of total weight of the resin composition for the encapsulation layer.
